(19) United States
(12) Patent Application Publication
(10) Pub. No.: US 2026/0206668 A1
(43) Pub. Date: Jul. 23, 2026

(54) AGRICULTURAL MACHINE GUIDANCE DURING UNLOADING

(71) Applicant: Deere & Company, Moline, IL (US)

(72) Inventors: Joseph P. Boyer, Cedar Falls, IA (US); Carroll C. Kellum, Cedar Falls, IA (US)

(21) Appl. No.: 19/570,405

(22) Filed: Mar. 18, 2026

Related U.S. Application Data
(63) Continuation of application No. 17/179,861, filed on Feb. 19, 2021.
(60) Provisional application No. 63/074,589, filed on Sep. 4, 2020.

(51) Int. Cl. A01B 69/00; A01D 90/10

(52) U.S. Cl. CPC A01B 69/001; A01D 90/10

(57) ABSTRACT

A method of controlling a tractor coupled to a grain cart includes determining an angle that a grain cart is pivoted, relative to a tractor, at a coupling point between the tractor and grain cart, receiving a distance sensor signal indicative of a distance from the tractor to a linear surface of a stationary grain trailer in a grain cart unloading operation from the grain cart to the stationary grain trailer, and generating a steering output based on the distance from the tractor to the linear surface of the stationary grain trailer, the determined angle, and a prescribed lateral distance from the linear surface of the stationary grain trailer. A steering system is controlled based on the steering output to maintain the prescribed lateral distance from the linear surface of the stationary grain trailer.

### CROSS-REFERENCE TO RELATED APPLICATIONS

The present application is a continuation of and claims priority to U.S. patent application Ser. No. 17/179,861, filed Feb. 19, 2021, which is based on and claims the benefit of U.S. provisional patent application Ser. No. 63/074,589, filed Sep. 4, 2020; the contents of these applications are hereby incorporated by reference in their entirety.

### FIELD OF THE DESCRIPTION

The present description generally relates to controlling a work machine. More specifically, but not by limitation, the present description generally relates to guidance of an agricultural machine during an unloading operation.

### BACKGROUND

An agricultural harvester, such as a combine, generally accumulates harvested material during operation. During such harvesting operations, it sometimes becomes necessary to transfer the harvested material from the harvester so that the harvester does not reach its storage capacity. Typically, a grain cart or wagon is towed by a tractor and is positioned next to the harvester as the harvester moves through the field. A transfer mechanism, such as an auger, transfers the agricultural material from the harvester to the grain cart or wagon. Once the grain cart or wagon is sufficiently filled, it is moved to a receiving vehicle such as one or more semi-trailers. The position of the semi-trailer(s) is not preset or known ahead of time. Instead, the semi-trailers are usually moved to an arbitrary position in a general loading area of the field. The tractor operator must drive to the arbitrary position of the trailer and position the tractor and grain cart relative to the trailer(s) in order to begin unloading the grain cart.

The operator of the tractor must then carefully maneuver the grain cart or wagon relative to the trailer(s) as the auger of the grain cart causes the harvested material to travel through a transport chute and be deposited into the trailer(s). As the transfer of the harvested material occurs, it is generally necessary for the operator of the tractor to adjust the feed rate of the product (typically by varying the PTO speed and grain cart auger gate) as well as to adjust the forward or backward movement of the tractor and grain cart relative to the trailer(s). Further, the tractor operator must also maintain a suitable lateral distance between the grain cart and the trailer(s) as the tractor moves forward or backward during the unloading operation.

For operators of grain carts, getting the correct offset and alignment with respect to the trailer(s) can be a challenging part of the unloading process. If the offset or alignment is incorrect, the grain cart could contact the trailer resulting in damage. Another possibility of such incorrect alignment or offset is the spillage of harvested material which is also very undesirable. Thus, if the alignment or offset is even slightly off, most the operator's focus will be on correcting the grain spout's position instead of efficiently filling the length of the trailer(s) without spilling. Although poor offset and alignment do not always result in spilled grain, it does usually result in a more stressful operation.

The discussion above is merely provided for general background information and is not intended to be used as an aid in determining the scope of the claimed subject matter.

### SUMMARY

A mobile agricultural machine includes a steering system configured to steer the mobile agricultural machine. At least one distance sensor is mounted on the mobile agricultural machine and is configured to provide a distance sensor signal indicative of a distance from the mobile agricultural machine to a surface of a remote object. A controller is operably coupled to the steering system and the at least one distance sensor. The controller is configured to receive an operator input enabling object detection and responsively monitor the distance sensor signal of the at least one distance sensor to detect a linear object surface and to responsively generate a steering output to the steering system to maintain a prescribed lateral distance from the detected linear object surface.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a top plan view of a grain cart unloading grain into a grain trailer of a semi-trailer.

FIG. 2 is a top plan view of a grain cart unloading operation in accordance with one embodiment.

FIG. 3 is a system block diagram of a control system in accordance with one embodiment.

FIG. 4 is a diagrammatic view of a screenshot provided by a user interface in accordance with one embodiment.

FIG. 5 is a flow diagram of a method of automatically guiding a tractor during a grain cart unloading operation in accordance with one embodiment.

FIG. 6 is a flow diagram of a method of engaging automatic grain cart unloading guidance in accordance with one embodiment.

FIG. 7 is a diagrammatic view illustrating a tractor and grain cart approaching a trailer in accordance with one embodiment.

FIG. 8 is a diagrammatic view of a state machine illustrating how an operator may override a specific instance for a period of time over a set of conditions and then allow automatic steering to become active again in accordance with one embodiment.

FIG. 9 is one embodiment of a computing environment in which elements of FIG. 3, or parts of it, (for example) can be deployed.

### DETAILED DESCRIPTION

In accordance with various embodiments described below, one or more sensors are placed on the chassis of a tractor to detect another object and determine the distance and angle to the other object, such as a grain trailer. The sensor(s) may continuously or substantially continuously provide information to a controller of other suitable device to identify a potential object to against which steering guidance can be provided. In one example, when the system is enabled, and the tractor speed is within a pre-defined range or below a pre-defined speed, and the system identifies, using the one or more sensors, a potential guidance object, the system notifies the operator of the tractor that guidance is possible. In some examples, the system may notify the operator that the object to guide against has been identified and that guidance will automatically begin within a certain amount of time unless cancelled by the operator. In other examples, the system may notify the operator that an object to guide against has been identified and then receive a manual input (e.g. cancel or accept) and then selectively engage guidance. Regardless, once the sensor(s) is/are used to begin machine guidance, the system uses real-time measurements of the one or more sensors along with historical measurements to guide the tractor relative to the detected object. This facilitates allowing the grain cart operator (i.e., driver of the tractor) to not have to think about maintaining the proper distance between the grain cart and the grain trailer as the unloading operator occurs. Further, the operator need not physically steer the tractor, thus reducing the need for the operator look backward and forward as often. Instead, the operator may simply focus on controlling the PTO speed and grain cart auger rate in order to control the flow rate from the grain cart to the trailer. This results in an easier, less error-prone process. Such process is particularly important given that operators of grain carts may be working long shift during the harvest and any improvements to the process of unloading can help reduce user errors and stress.

Throughout this description, the terms user and operator are used interchangeably.

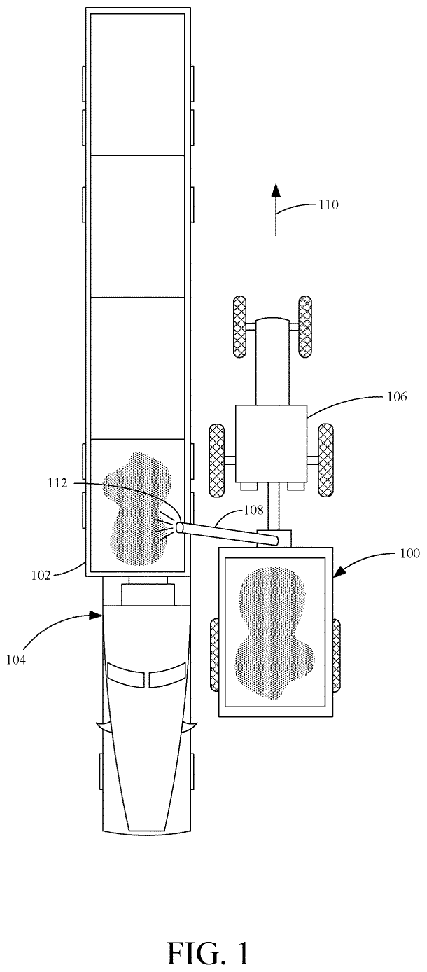

FIG. 1 is a top plan view of a grain cart 100 unloading grain into a grain trailer 102 coupled to a semi-truck 104. During this unloading operation, the truck 104 is usually stationary, and the operator of grain cart 100 will typically approach trailer 102 from the operator's left side. However, while embodiments will be described with respect to unloading occurring on the operator's left side, it is expressly contemplated that unloading embodiments can be practiced using either side of grain cart 100. In order to initiate the unloading operation, the operator of tractor 106 position tractor 106 to drive alongside trailer 102 and will engage suitable hydraulics to fine tune the position of chute 108 over trailer 102. Then, the operator will engage the grain cart auger and control the auger gate position using tractor hydraulics in order to begin the flow of grain through chute 108 from cart 100 into trailer 102. As the grain begins to fill the portion of trailer 102, the operator will cause tractor 106 to move in the direction indicated by arrow 110 such that spout 112 of chute 108 is displaced rearwardly in trailer 102. In this way, trailer 102 is generally filled from one direction to another. In the example shown, this is from the front direction to the rear of the trailer. However, unloading can also occur with the grain cart approaching from the opposite side and filling from the rear to the front of trailer 102. Further still, it is also known to fill the trailer from the rear to the front by operating tractor 106 in reverse.

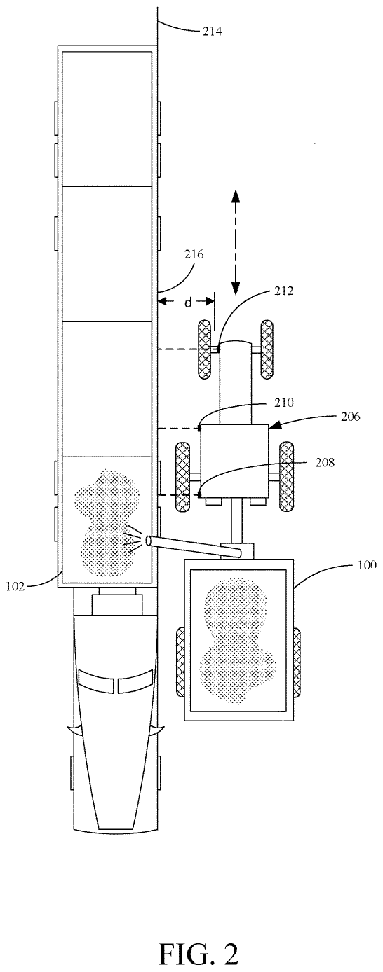

FIG. 2 is a top plan view of a grain cart unloading operation in accordance with one embodiment. As can be seen, the embodiment illustrated in FIG. 2 shares some similarities with the process shown in FIG. 1. In particular, embodiments can be practiced with legacy grain cart 100 that does not include any special adaptations or configurations described herein. The embodiment illustrated in FIG. 2 provides one or more distance sensors 208, 210, and 212 on tractor 206. In the illustrated example, these sensors are disposed on the left side of tractor 206. However, those skilled in the art will appreciate that one or more additional sensors could be positioned on the right side of tractor 206 as well. Sensors 208, 210, and 212 may be any suitable sensors that provide a distance reading or indication with respect to a detected object's surface. Examples of sensors 208, 210, and 212 are RADAR sensors, LIDAR sensors, and ultrasonic sensors. While any suitable type of sensor or combination of types of sensors can be used, it is preferred that sensors 208, 210, and 212 be ultrasonic sensors by virtue of their low cost. Sensor(s) 208, 210, and 212 generally emit a signal outwardly from the left side of tractor 206. When an object is near tractor 206, the object reflects the signal and the reflection is signal is detected by the sensor.

Each of sensors 208, 210, and 212 is configured to provide a signal indicative of a distance to the object's surface. Knowing the position of each individual sensor 208, 210, and 212 on tractor 206 allows a controller or other suitable system coupled to sensors 208, 210, and 212 to identify one or more objects based on the combination of signals from sensors 208, 210, and 212. Of particular interest, is the identification of a straight line, such as line 214 generated by edge 216 of trailer 102. When a straight-line edge is detected, embodiments can automatically, or semi-automatically, engage guidance of tractor 206 in order to maintain a set lateral offset or prescribed lateral distance (d) and alignment between grain cart 100 and trailer 102 as tractor 206 moves along trailer 102. In this way, the operator within tractor 206 need not focus on the task of steering the tractor, but instead may focus solely on controlling the transfer of material from gain cart 100 into trailer 102 and ensure that trailer 102 is filled efficiently as tractor 206 moves along trailer 102.

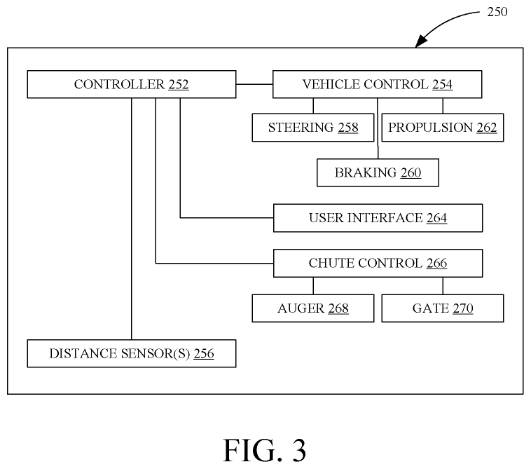

FIG. 3 is a block diagram of a control system in accordance with one embodiment. Control system 250 is generally operative within tractor 206 and is configured to use the signals from one or more distance sensors in order to provide automated or semi-automated machine guidance during grain cart unloading. System 250 includes controller 252 which may be any suitable device able to execute one or more programmatic steps or logic states in order to provide a control function using one or more distance sensor signals to guide the tractor. In one embodiment, controller 252 is a microprocessor. Controller 252 may be coupled to vehicle control module 254 in order to provide one or more guidance signals to the vehicle control module 254. Alternatively, controller 252 may be embodied within or a component of vehicle control module 254. In such instances, the signals from one or more distance sensors 256 may be provided directly to vehicle control module 254.

Vehicle control module 254 is configured to generate suitable actuation signals in order to control steering 258 of tractor 206, braking 260, and propulsion 262. Steering system 258, braking system 260, and propulsion system 262 are generally associated with tractor 260 or a propulsion vehicle (e.g., propulsion vehicle portion of a grain cart) for moving and controlling the movement of tractor 206, and thus grain cart 100, as directed manually by a human operator manning vehicle controls or user interface 264, or as instructed automatically by controller 252. Steering system 258 may comprise an electro-hydraulic steering system, an electro-mechanical steering system, an electric motor steering system, or another electrically or electronically controllable steering device for controlling the heading of tractor 206. Braking system 260 may comprise an electro-hydraulic braking system, an electro-mechanical braking system, or another electrically or electronically controllable braking device for stopping or decelerating tractor 206. Propulsion system 262 may comprise an internal combustion engine and an engine controller (e.g., for controlling air and fuel metering), or an electric motor and controller, for propelling tractor 206.

Controller 252 is also coupled to chute control module 266 which is configured to control the auger 268 within chute 108 and gate 270 of chute 108.

As set forth above, distance sensor(s) 256 may be RADAR sensors, LIDAR sensors, ultrasonic sensors, or monocular or stereovision cameras. A LIDAR sensor is a sensor that measures a distance by illuminating a target with laser light and measuring the reflection with a sensor. Difference in laser return times and wavelengths can then be used to calculate a distance. Typically, by recording the return time, LIDAR provides a measure of distance. A RADAR sensor is similar but uses a different portion of the electromagnetic spectrum. Thus, RADAR uses an RF signal that reflects from an object and is detected by a sensor. The time required for the RADAR signal to depart, reflect off the object, and return provides an indication of distance to the object. An ultrasonic distance sensor measures or detects a distance to an object using ultrasonic sound waves. An ultrasonic distance sensor uses a transducer to send and receive ultrasonic pulses that relay back information about an object's proximity. As can be appreciated, all three described sensors generally issue a signal in the form of light, RF energy, or sound, and measure the amount of time it takes for the reflected energy from the object to be detected. Also, as set forth above, ultrasonic sensors are generally preferred due to their low cost. However, it is also expressly contemplated that combinations of sensors can be used in order to provide a balance of range versus cost. For example, RADAR is generally known to provide a distance measurement with higher range, but, perhaps, with lower precision than an ultrasonic sensor. An ultrasonic sensor, is generally inexpensive, and has a limited range, but provides a very precise signal with respect to distance.

In embodiments that employ monocular or stereovision cameras, the image(s) from the camera(s) is/are provided to a machine vision processor in order to identify objects of interest (e.g. a trailer) and provide information indicative of a position and orientation of the objects relative to the grain cart.

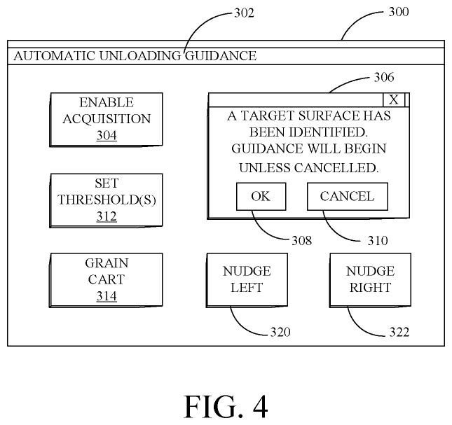

FIG. 4 is a diagrammatic view of a screenshot provided by a user interface module, such as user interface module 264 coupled to controller 252. Screenshot 300 generally includes a function heading 302 for the operator indicating that the operator is interacting with an Automatic Unloading Guidance function. Within this function, the operator may enable or disable automatic acquisition of target object surfaces by pressing soft button 304. Once button 304 has been engaged, controller 252 will continuously monitor signals from the one or more distance sensors 208, 210, 212 in order to identify a suitable straight line upon which guidance may be based. Such a straight line is typically provided when the tractor comes into proximity of a trailer edge 216. When such a potentially-guidable edge has been detected, user interface 264 issues a popup or other suitable message 306 such as, “A target surface has been identified. Guidance will begin unless cancelled.” Additionally, this message may include a confirmation button “OK” 308 and/or a cancel button 310. If the user presses OK button 308, the system will immediately begin guiding off the detected edge. However, if the user presses cancel button 310, then the detected edge will not be used for guidance. In the event that the user does not press either button 308 or 310 within a specified amount of time, such as 15 seconds, the system will automatically begin guiding off the detected edge.

As shown in FIG. 4, user interface 264 may also provide a user interface element, such as button 312 that allows the user to set one or more relevant thresholds for operation of the automatic unloading guidance. One particular set of thresholds is to set a target tractor speed range within which the automatic guidance will operate. Such threshold may include a minimum speed threshold and a maximum speed threshold thus defining a speed band within which automatic guidance will be provided, and/or automatic edge acquisition from monitoring sensors 208, 210, and 212 will be performed. Thus, if tractor 206 is moving at a higher speed than the maximum speed threshold, controller 252 will not be continuously searching for edges upon which to guide tractor 206.

Another relevant threshold is the angle between a detected edge and the heading of tractor 206. For example, if an edge is detected, but is 45 degrees from the heading of the tractor, the edge may not be suitable for guidance. Thus, the edge threshold may set a maximum angle between the detected edge and the heading of tractor 206. Such angle may be set to have a maximum of 15 degrees, or any suitable user-supplied value.

User interface 264 may provide a user interface element, or button 314 that allows the user to enter grain cart information. The specification of grain cart information, such as a model number or identification of the grain cart, allows controller 252 to access a suitable grain cart mathematical model that corresponds to the selected model number or identification of the grain cart in order to identify the length, width and chute position relative to the tractor (i.e. coupling between tractor 206 and grain cart 100) of any known grain cart. Accordingly, the specified grain cart information allows controller 252 to access the model in order to correlate the physical position of tractor 206 with the position of the towed, selected, grain cart.

User interface 264 may also provide one or more user interface elements, such as soft buttons 320, 322 that allow the operator to nudge the tractor closer or farther from trailer 102 during the guided unloading operation. Preferably, the nudge will correspond to a finite adjustment (e.g. 2 inches) in the distance, which will then be maintained by the system for the remainder of the operation or until a subsequent nudge is received.

User interface 264 may also engage a force actuator in the steering system to indicate to the operator of the tractor that the system has identified a suitable source for guidance is assuming steering control of the tractor. At the point, the operator may release the steering wheel to allow automatic steering, or the operator could overpower the force to cancel the engagement.

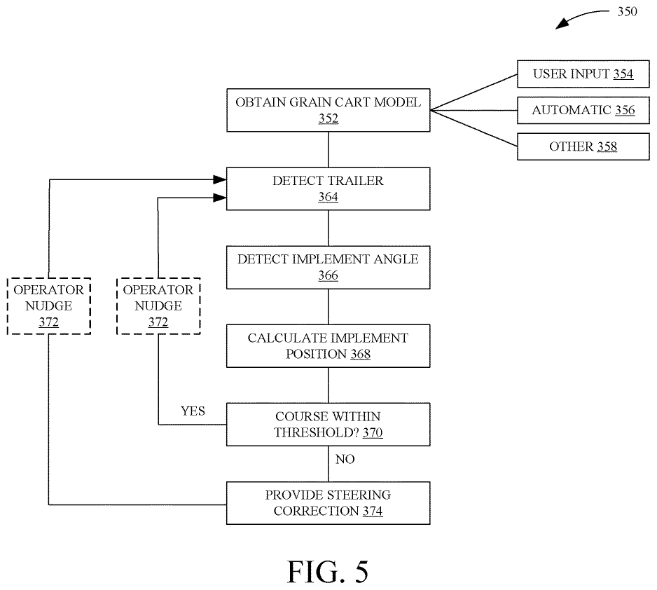

FIG. 5 is a flow diagram of a method of automatically guiding a tractor during a grain cart unloading operation in accordance with one embodiment. Method 350 begins at block 352 where a grain cart model information is obtained. This model may be obtained by a user entering a model number or other suitable information relative to the grain cart, as indicated at block 354, and then controller 252 accessing a data store having grain cart dimensional model information that corresponds to grain cart model numbers. For example, a Model 100 Grain Cart may have length, width, and chute position information stored in the data store. Alternatively, one or more automatic grain cart detection techniques can be used, as indicated at block 356. Examples of automatic grain cart detection can include electronically querying the grain cart, such as by interacting with an RFID tag on the grain cart, optically identifying the grain cart either by measuring its dimensions and position using a camera, or optically identifying visual indicia on the grain cart, such as a QR code or bar code. Additionally, as indicated at block 358, any suitable other technique for obtaining the grain cart model can be provided. Accordingly, method 350 employs the model of the grain cart to determine the grain cart position relative to the tractor.

Next, at block 364, a trailer is detected. The system determines the detected edge of the trailer both in terms of lateral distance and angle relative to the course of the tractor. The trailer position is generally a relative distance or lateral separation between the tractor and the detected edge, such as edge 216 (shown in FIG. 2). Additionally, the trailer position detection may include a comparison of the tractor heading relative to the detected edge. Next, at block 366, the implement angle is measured or otherwise determined. The implement angle may be provided directly by an encoder or sensor positioned at the interface/coupling between the tractor and implement (i.e. grain cart), or in any other suitable manner, such as by using a system model. At block 368, controller 252 calculates the implement position relative to the detected line using the model of the grain cart (i.e. dimensions, etc.), the detected angle of the grain cart, the position of the tractor, and the detected separation (lateral distance and course) from the detected line. In some examples, the angle of the grain cart may be calculated based on a model.

At block 370, controller 252 determines whether the calculated position of the grain cart as well as the course of the tractor is within a specified threshold. If the lateral distance is within the specific threshold and the heading of the tractor, relative to the detected edge, is within a specified threshold of parallelism (e.g., 3°) the course is deemed acceptable, and control returns to block 364. As shown in FIG. 5, at any time during the operation of method 350, the operator may provide an input (e.g. nudge), such as via one or more operator controls or user interface 264 to nudge the tractor steering left or right, as indicated at block 372. Upon receiving an operator nudge, method 350 will maintain the nudged distance between the grain cart and the trailer.

As indicated at block 374, if the determination at block 370 indicates that the course is not within a specified threshold, then control passes to block 374. This occurs when either the distance between the grain cart and the detected edge is either too small or too large, or if the heading of tractor 206 is not parallel to the detected edge within a specified threshold, such as 3°, then controller 252 calculates a steering correction that is provided to tractor control module 254 in order to guide the steering of tractor 206 to achieve and maintain a substantially parallel path of requisite distance between the grain cart and the trailer.

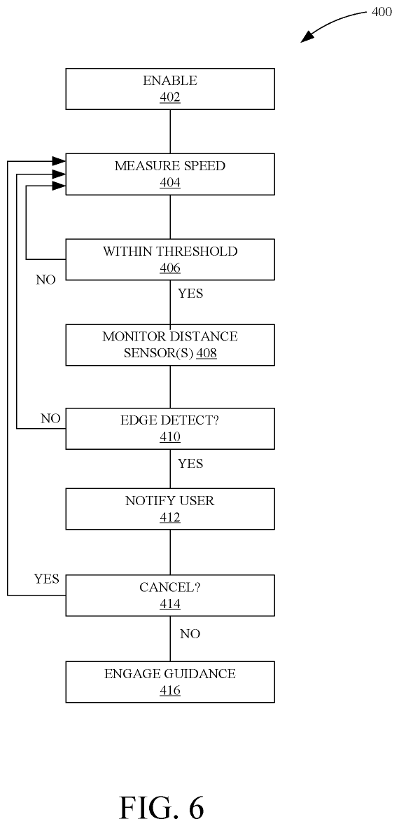

FIG. 6 is a flow diagram of a method of engaging automatic grain cart unloading guidance in accordance with one embodiment. Method 400 begins at block 402 where a user enables automatic or semiautomatic engagement, as described above. In one example, the method may be enabled by a user pressing “enable acquisition” user interface element 304, as shown in FIG. 4. Once enabled, control passes to block 404, where tractor speed is measured. Next, at block 406, the measured tractor speed is compared with one or more speed thresholds to determine if the speed is within a specified speed range, or below a specified maximum speed. If not, control returns to block 404 and the method simply iterates until the tractor speed is within the specified threshold, or below a specified maximum, at which time control passes to block 408, where signals from one or more distance sensors on the tractor are monitored. Next, at block 410, based on the monitored sensor signals, the method determines whether an edge has been detected. The detection of an edge presents a unique sensor return pattern in that the distance from the tractor to a detected edge will be indicative of a line. If such a line or edge is not detected, control returns to block 404. If, however, at block 410, controller 252 determines that an edge has been detected, then control passes to block 412 where the user may be notified. For example, a notification may be generated on a user interface screen, such as indicated at reference numeral 306 in FIG. 4. Once notified, control passes to block 414 where method 400 determines whether a user has cancelled automatic guidance. If so, control returns to block 404. If not, however, control passes to block 416, where automatic steering guidance of the tractor is initiated in order to guide the grain cart along the detected edge.

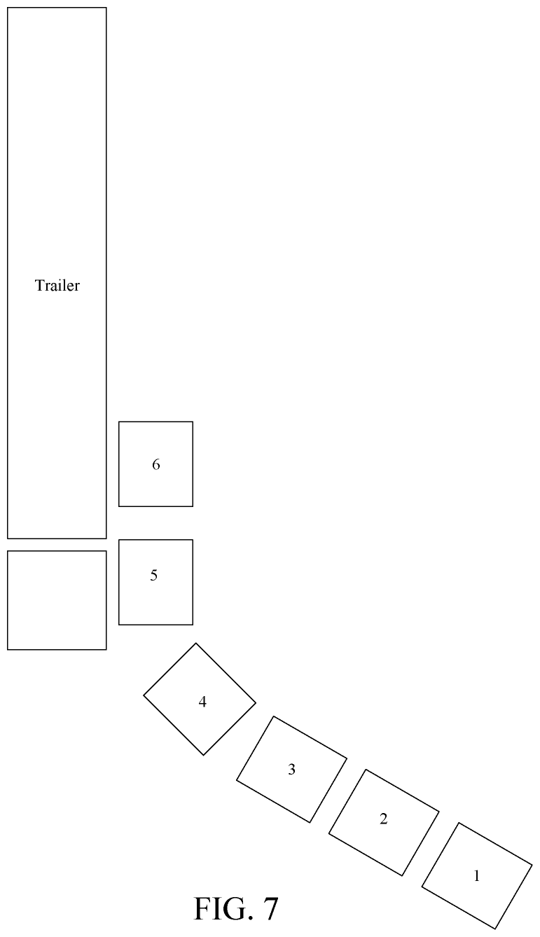

FIG. 7 is a diagrammatic view illustrating a tractor and grain cart approaching a trailer in accordance with one embodiment. As shown, the tractor and grain cart are represented by a rectangular box at a number of positions 1-6. At position 1, the tractor and grain cart are approaching the trailer. At position 2, one or more sensors on the tractor provide signals indicative of detection of the trailer. This generates a notification to the operator of the tractor who may then engage automatic steering before the tractor is in-line with the trailer. Alternately, the notification may indicate that automatic steering will begin unless cancelled by the operator. Regardless, automatic steering of the tractor can be initiated before the tractor is in-line with the trailer. Next, at position 3, the automatic steering is initiated. At position 4, the automatic steering has corrected the heading of the tractor to begin aligning the tractor and grain cart relative to the trailer. At position 5, the automatic steering continues steering the tractor to maintain alignment and lateral spacing with the trailer. At position 6, the automatic steering maintains the alignment and pre-selected distance between the tractor and the trailer.

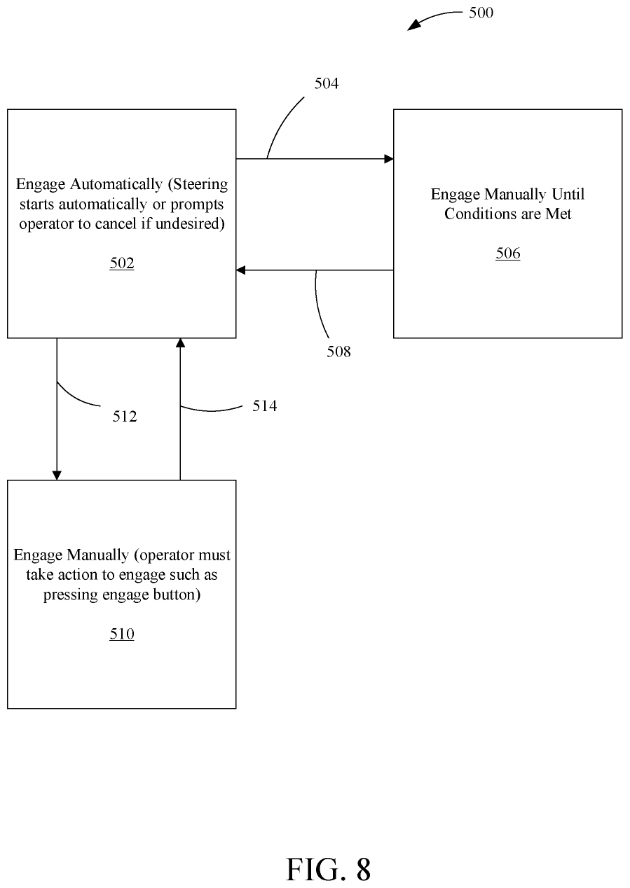

FIG. 8 is a diagrammatic view of a state machine illustrating how an operator may override a specific instance for a period of time over a set of conditions and then allow automatic steering to become active again in accordance with one embodiment. State machine 500 enters an initial state at block 502, where the system has identified a suitable object upon which guidance can be provided (i.e. edge of a trailer). At block 502, the system, in the illustrated embodiment, automatically engages steering or prompts the operator of the tractor to cancel if undesired. If the operator overrides steering, for example by grabbing the steering wheel and overpowering the steering, then the state machine passes to state 506 via line 504. While in state 506, the tractor steering is under manual (i.e. operator) control until one or more suitable conditions are met. Examples of conditions include the tractor travelling beyond a selected distance, a certain amount of time elapsing since manual control began, and/or the tractor travelling above a certain speed. Any combination of these conditions can be used to determine when the state machine transitions back to automatic steering at block 502 via line 508. Similarly, when automatic steering is to engage at block 502, the operator may simply cancel the automatic steering, such as via a control or button in the cab of the tractor. When this occurs, the state machine transitions from block 502 to block 510 via line 512. When the operator has so disengaged the system, it will remain disengaged until the operator specifically engages automatic steering. Upon operator engagement of automatic steering, the state machine returns to block 502 via line 514. A benefit to these states is to allow an override once until an unload is done completely manually. In a subsequent trip back to unload, the automatic engagement could occur again by re-entering the “engage automatically” state.

Embodiments described herein generally facilitate the semi-automatic unloading of a grain cart into a grain trailer. This is important because during harvest, the position of the trailer is not fixed in the field. Trailers come in and out of the field all day and their positions are generally unknown to the system. Even if the positions of the trailers could be known by virtue of GPS, the accuracy required to map them via GPS and communicate that to the tractor would be prohibitively expensive. Accordingly, solutions described above generally provide one or more sensors on the tractor which determine a distance from the tractor to another object, such as a grain trailer. The system continuously monitors the information generated by the sensors to identify a potential object to guide against. When the tractor speed is within an adequate range, and the system has identified a potential guidance object, the system generally notifies the operator that guidance is possible. When the operator engages guidance, or fails to cancel guidance, the system will use real-time measurements of the sensors along with historical measurements to guide the tractor relative to the object. Guidance of the tractor is traditionally done through the electro-hydraulic steering system.

The methods described above generally allow the tractor to be steered such that the tractor, and thus the grain cart, is maintained at a specified distance from the detected object. As described, in order to maintain any suitable grain cart at a specified distance from the detected object, a model of the grain cart is generally obtained and is used in order to correlate the tractor position to the grain cart position. This model receives as an input, the angle between the tractor and the implement. However, in some examples, the model may be used to calculate the angle of the implement using previous known steering angles and wheel speed. Further, the operator may also enter additional parameters for the grain cart in order to improve the accuracy of the model. As the system operates, the pattern of sensor signals is monitored in order to automatically identify that the tractor is approaching an object of interest, and particularly an object having an edge upon which guidance can be based. When such an edge is identified, guidance is automatically, or semi-automatically engaged in order to avoid the operator having to press an engagement button for each grain unloading operation. In this way, the system also provides a user interface or other suitable techniques to allow the operator to nudge the distance smaller or larger, as desired. The system also allows the operator to engage the system without a potential object, if desired, and simply drive straight for a predetermined distance or time allowing the method to continuously look for an object upon which to guide against. Once such an object is found, guidance is provided automatically. As can be appreciated, the automatic techniques for steering the tractor, can be overridden by the operator by simply seizing the steering wheel of the tractor and turning the wheel greater than a specified threshold, such as 20°. Additionally, the system may be disabled by explicit user input, such as pressing a disable button, or other suitable operator inputs.

The present discussion has mentioned processors and controllers. In one embodiment, the processors and controllers include computer processors with associated memory and timing circuitry, not separately shown. They are functional parts of the systems or devices to which they belong and are activated by, and facilitate the functionality of the other components or items in those systems.

Also, a number of user interface displays have been discussed. They can take a wide variety of different forms and can have a wide variety of different user actuatable input mechanisms disposed thereon. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands.

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

It will be noted that the above discussion has described a variety of different systems, components and/or logic. It will be appreciated that such systems, components and/or logic can be comprised of hardware items (such as processors and associated memory, or other processing components, some of which are described below) that perform the functions associated with those systems, components and/or logic. In addition, the systems, components and/or logic can be comprised of software that is loaded into a memory and is subsequently executed by a processor or server, or other computing component, as described below. The systems, components and/or logic can also be comprised of different combinations of hardware, software, firmware, etc., some examples of which are described below. These are only some examples of different structures that can be used to form the systems, components and/or logic described above. Other structures can be used as well.

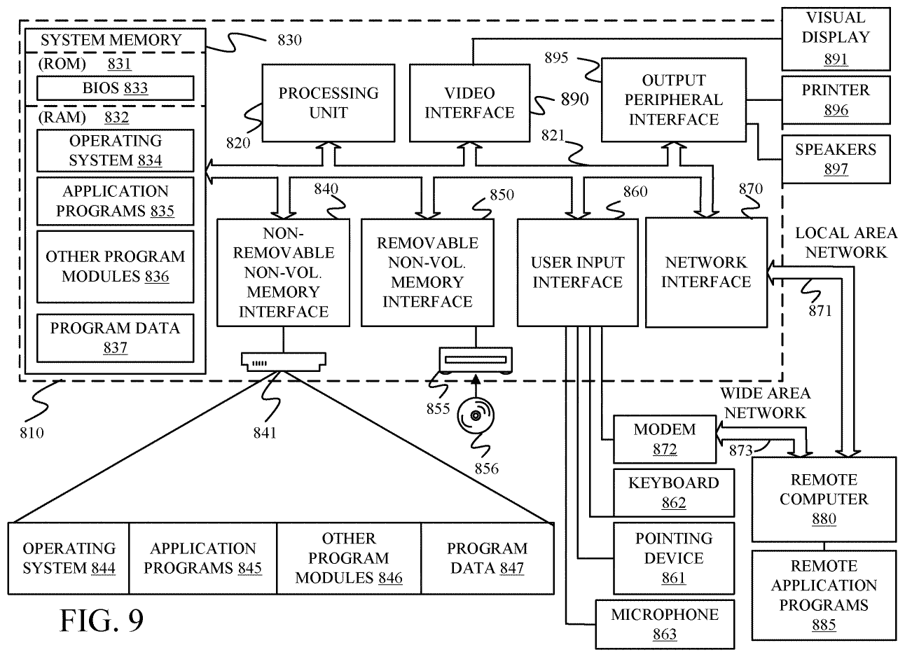

FIG. 9 is one embodiment of a computing environment in which elements of FIG. 3, or parts of it, (for example) can be deployed. With reference to FIG. 9, an exemplary system for implementing some embodiments includes a general-purpose computing device in the form of a computer 810. Components of computer 810 may include, but are not limited to, a processing unit 820 (which can comprise processor 108), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. Memory, instructions, and functions described with respect to FIG. 3 can be deployed in corresponding portions of FIG. 9.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media may embody computer readable instructions, data structures, program modules or other data in a transport mechanism and includes any information delivery media. The term “modulated data signal” means a signal that has one or more of its characteristics set or changed in such a manner as to encode information in the signal.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 8 illustrates operating system 834, application programs 835, other program modules 836, and program data 837.

The computer 810 may also include other removable/non-removable volatile/nonvolatile computer storage media. By way of example only, FIG. 9 illustrates a hard disk drive 841 that reads from or writes to non-removable, nonvolatile magnetic media, a magnetic disk drive 851, nonvolatile magnetic disk 852, an optical disk drive 855, and nonvolatile optical disk 856. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (e.g., ASICs), Program-specific Standard Products (e.g., ASSPs), System-on-a-chip systems (SOCs), Complex Programmable Logic Devices (CPLDs), etc.

The drives and their associated computer storage media discussed above and illustrated in FIG. 9, provide storage of computer readable instructions, data structures, program modules and other data for the computer 810. In FIG. 9, for example, hard disk drive 841 is illustrated as storing operating system 844, application programs 845, other program modules 846, and program data 847. Note that these components can either be the same as or different from operating system 834, application programs 835, other program modules 836, and program data 837.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures. A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections (such as a local area network—LAN, or wide area network WAN) to one or more remote computers, such as a remote computer 880.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. In a networked environment, program modules may be stored in a remote memory storage device. FIG. 9 illustrates, for example, that remote application programs 885 can reside on remote computer 880.

It should also be noted that the different embodiments described herein can be combined in different ways. That is, parts of one or more embodiments can be combined with parts of one or more other embodiments. All of this is contemplated herein.

Example 1 is a mobile agricultural machine comprising a steering system configured to steer the mobile agricultural machine and at least one distance sensor mounted on the mobile agricultural machine and configured to provide a distance sensor signal indicative of a distance from the mobile agricultural machine to a surface of a remote object. A controller is operably coupled to the steering system and the at least one distance sensor. The controller is configured to receive an operator input enabling object detection and responsively monitoring the distance sensor signal of the at least one distance sensor to detect a linear object surface and to responsively generate a steering output to the steering system to maintain a prescribed lateral distance from the detected linear object surface.

Example 2 is the mobile agricultural machine of any or all previous examples, wherein the mobile agricultural machine is a tractor.

Example 3 is the mobile agricultural machine of any or all previous examples, wherein the at least one distance sensor includes an ultrasonic sensor.

Example 4 is the mobile agricultural machine of any or all previous examples, wherein the at least one distance sensor includes a LIDAR sensor.

Example 5 is the mobile agricultural machine of any or all previous examples, wherein the at least one distance sensor includes a RADAR sensor.

Example 6 is the mobile agricultural machine of any or all previous examples, wherein the at least one distance sensor includes a camera.

Example 7 is the mobile agricultural machine of any or all previous examples, wherein the at least one distance sensor includes a plurality of distance sensors spaced apart on the mobile agricultural machine.

Example 8 is the mobile agricultural machine of any or all previous examples, wherein the mobile agricultural machine is coupled to a grain cart and wherein the controller includes model information relative to the grain cart.

Example 9 is the mobile agricultural machine of any or all previous examples, wherein the grain cart model information relates a position of the mobile agricultural machine to a position of the grain cart and wherein the controller is configured to provide the steering output to maintain a prescribed lateral distance from grain cart and the detected linear object surface.

Example 10 is the mobile agricultural machine of any or all previous examples, wherein the controller is coupled to a user interface to receive operator input indicative of grain cart model information.

Example 11 is the mobile agricultural machine of any or all previous examples, wherein the controller is coupled to a user interface to receive operator input indicative of at least one threshold for determining when to responsively generate steering guidance.

Example 12 is the mobile agricultural machine of any or all previous examples, wherein the threshold includes a maximum speed threshold under which, the controller will monitor the distance sensor signal.

Example 13 is the mobile agricultural machine of any or all previous examples, wherein the threshold includes a maximum course deviation of the mobile agricultural machine relative to the detected linear object.

Example 14 is the mobile agricultural machine of any or all previous examples, wherein the controller is configured to provide a notification that the linear object surface has been detected and provide a user interface element allowing the operator to cancel generation of the steering output to the steering system.

Example 15 is a method of controlling a mobile agricultural machine during an unloading operation. The method includes obtaining grain cart information for a grain cart coupled to the mobile agricultural machine; detecting a position of the mobile agricultural machine relative to a lateral linear surface; detecting an angle of the grain cart relative to the mobile agricultural machine; calculating a position of the grain cart relative to the lateral linear surface using the grain cart information, the position of the mobile agricultural machine, and the angle of the grain cart relative to the mobile agricultural machine; and selectively providing a steering control signal to the mobile agricultural machine based on the position of the grain cart relative to the lateral linear surface.

Example 16 is the method of any or all previous examples, wherein detecting a position of the mobile agricultural machine is performed using a plurality of distance sensors mounted to the mobile agricultural machine.

Example 17 is the method of any or all previous examples, further comprising detecting operator input indicative of a nudge and responsively controlling the steering control signal to adjust a lateral distance between the grain cart and the lateral linear surface.

Example 18 is a method of providing guidance to a mobile agricultural machine. The method includes receiving user input enabling object detection; measuring a speed of the mobile agricultural machine; determining if the measured speed is within a threshold for object detection; selectively monitoring a signal of at least one distance sensor mounted to the mobile agricultural machine based when the measured speed is within the threshold for object detection; detecting a linear edge of an object while selectively monitoring the signal of the at least one distance sensor; generating a notification that the linear edge has been detected; and selectively engaging automatic steering guidance based on an operator response to the notification.

Example 19 is the method of any or all previous examples, wherein selectively engaging automatic steering guidance includes engaging automatic steering guidance if no operator input is received within a set time after generation of the notification.

Example 20 is the method of any or all previous examples, wherein selectively engaging automatic steering guidance includes delaying automatic engagement after an operator override without requiring any further operator input.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A tractor configured to pull a grain cart, the tractor comprising:
a coupling point, wherein the grain cart is pivotably coupled to the tractor at the coupling point such that the grain cart is pivotable relative to the tractor when pulled by the grain cart;
a steering system configured to steer the tractor;
one or more distance sensors mounted on the tractor, wherein each distance sensor, of the one or more distance sensors, is configured to:
detect a linear surface of a stationary grain trailer in a grain cart unloading operation from the grain cart to the stationary grain trailer, and
provide a distance sensor signal indicative of a distance from the tractor to the linear surface of the stationary grain trailer; and
a controller configured to:
determine an angle that the grain cart is pivoted, relative to the tractor, at the coupling point between the tractor and grain cart;
generate a steering output based on:
the distance from the tractor to the linear surface of the stationary grain trailer,
the determined angle that the grain cart is pivoted, relative to the tractor, at the coupling point between the tractor and grain cart, and
a prescribed lateral distance from the linear surface of the stationary grain trailer; and
control the steering system based on the steering output to maintain the prescribed lateral distance from the linear surface of the stationary grain trailer as the tractor and the grain cart move relative to the stationary grain trailer during the grain cart unloading operation.

2. The tractor of claim 1, wherein at least one distance sensor of the one or more distance sensors, is configured to issue a signal, while object detection is enabled, the signal being in the form of at least one of light, RF energy, and sound.

3. The tractor of claim 1, wherein at least one distance sensor, of the one or more distance sensors, includes an ultrasonic sensor.

4. The tractor of claim 1, wherein at least one distance sensor, of the one or more distance sensors, includes a LIDAR sensor.

5. The tractor of claim 1, wherein at least one distance sensor, of the one or more distance sensors, includes a RADAR sensor.

6. The tractor of claim 1, wherein the controller is configured to provide a notification that the linear surface of the stationary grain trailer has been detected based on a speed of the tractor.

7. The tractor of claim 1, wherein the tractor comprises an angle sensor configured to sense the angle of the grain cart, relative to the tractor, at the coupling point.

8. The tractor of claim 1, wherein the controller is configured to determine the angle of the grain cart, relative to the tractor, at the coupling point based on a model.

9. The tractor of claim 8, wherein the model comprises a grain cart model that represents dimensions of the grain cart, and the controller is configured to determine a distance between the grain cart and the stationary grain trailer based on the grain cart model.

10. The tractor of claim 8, wherein the model correlates tractor position with grain cart position.

11. The tractor of claim 1, wherein the controller is configured to determine the angle based on at least one of a steering angle or wheel speed.

12. The tractor of claim 1, wherein the controller is coupled to a user interface to receive operator input indicative of one or more thresholds for determining when to responsively generate steering guidance, the one or more thresholds including at least one of:
a maximum speed threshold under which the controller will monitor the distance sensor signal,
a maximum course deviation of the tractor relative to the linear surface of the stationary grain trailer,
a minimum speed above which the controller will monitor the distance sensor signal, or a parallelism threshold under which the controller will monitor the distance sensor signal.

13. The tractor of claim 1, wherein detection of the linear surface of the stationary grain trailer includes detecting a lateral offset and an angle between the linear surface and a course of the tractor.

14. The tractor of claim 1, wherein the controller is configured to receive an operator input enabling object detection and, in response to enabling the object detection, responsively monitor the distance sensor signal to identify the linear surface of the stationary grain trailer.

15. A control system comprising:
at least one processor;
memory storing instructions executable by the at least one processor, wherein the instructions, when executed, cause the control system to:
determine an angle that a grain cart is pivoted, relative to a tractor, at a coupling point between the tractor and grain cart;
receive a distance sensor signal indicative of a distance from the tractor to a linear surface of a stationary grain trailer in a grain cart unloading operation from the grain cart to the stationary grain trailer;
generate a steering output based on:
the distance from the tractor to the linear surface of the stationary grain trailer,
the determined angle that the grain cart is pivoted, relative to the tractor, at the coupling point between the tractor and grain cart, and
a prescribed lateral distance from the linear surface of the stationary grain trailer; and
control a steering system based on the steering output to maintain the prescribed lateral distance from the linear surface of the stationary grain trailer as the tractor and the grain cart move relative to the stationary grain trailer during the grain cart unloading operation.

16. The control system of claim 15, wherein the angle is determined based on an angle sensor configured to sense the angle of the grain cart, relative to the tractor, at the coupling point.

17. The control system of claim 15, wherein the angle is determined based on a model.

18. A method of controlling a tractor coupled to a grain cart, the method comprising:
determining an angle that a grain cart is pivoted, relative to a tractor, at a coupling point between the tractor and grain cart;
receiving a distance sensor signal indicative of a distance from the tractor to a linear surface of a stationary grain trailer in a grain cart unloading operation from the grain cart to the stationary grain trailer;
generating a steering output based on:
the distance from the tractor to the linear surface of the stationary grain trailer,
the determined angle that the grain cart is pivoted, relative to the tractor, at the coupling point between the tractor and grain cart, and
a prescribed lateral distance from the linear surface of the stationary grain trailer; and
controlling a steering system based on the steering output to maintain the prescribed lateral distance from the linear surface of the stationary grain trailer as the tractor and the grain cart move relative to the stationary grain trailer during the grain cart unloading operation.

19. The method of claim 18, wherein determining the angle comprises determining the angle based on an angle sensor that senses the angle of the grain cart, relative to the tractor, at the coupling point.

20. The method of claim 18, wherein determining the angle comprises determining the angle based on a model.
